(19) United States
(12) Patent Application Publication
(10) Pub. No.: US 2023/0013829 A1
(43) Pub. Date: Jan. 19, 2023

(54) APPARATUS, SYSTEM AND METHOD FOR LIFTING A CONVEYOR BELT

(71) Applicants: TS Global Pty Ltd, Mayfield West, NSW (AU); The University of Newcastle, Callaghan, NSW (AU)

(72) Inventors: Craig Anthony Wheeler, Callaghan, NSW (AU); Jason Tom Willis, Callaghan, NSW (AU); Ilic Dusan, Callaghan, NSW (AU); Graham Dean Holford, Mayfield West, NSW (AU)

(21) Appl. No.: 17/756,794

(22) PCT Filed: Dec. 2, 2020
(86) PCT No.: PCT/AU2020/051309

§ 371 Date: Jun. 2, 2022

(30) Foreign Application Priority Data
Dec. 2, 2019 (AU) 2019904545

(51) Int. Cl. B66F 3/12; B65G 21/06

(52) U.S. Cl. CPC B66F 3/12; B65G 21/06

(57) ABSTRACT

An apparatus (10) adapted to lift a conveyor belt (12) relative to a supporting structure (14). The apparatus (10) includes a cradle (16) adapted to support the conveyor belt (12), a base arrangement (17) adapted to locate with the supporting structure (14) and a lifting mechanism (20) operatively coupled between the base arrangement (17) and the cradle (16) so that the conveyor belt is elevatable in a supported condition. The apparatus including a load sensor arrangement (22) configured to measure a load carried by the apparatus associated with lifting the belt. A system (100) including the apparatus (10) and method are also disclosed

### RELATED APPLICATIONS

This application claims priority from Australian provisional patent application no. 2019904545 filed 2 Dec. 2019, the contents of which are incorporated by reference.

### TECHNICAL FIELD

The invention relates to an apparatus, system and a method for lifting a conveyor belt.

### BACKGROUND

Conveyor belt lifters are used to elevate the conveyor belt for maintenance or splicing. Such belt lifters typically include a cradle to support the belt, a base to seat on the conveyor frame and a lifting mechanism to elevate the cradle relative to the base. Such conveyor belt lifters are typically designed to lift a predetermined maximum load.

A problem with known conveyor belt lifters is that the load to be lifted may be unknown or variable such as due to material on the belt or tension in the belt. Further, the load may change whilst in use. As such, the conveyor belt lifter may become overloaded or otherwise unsafe.

The invention disclosed herein seeks to overcome one or more of the above identified problems or at least provide a useful alternative.

### SUMMARY

In accordance with a first broad aspect there is provided, an apparatus adapted to lift a conveyor belt relative to a supporting structure, the apparatus including a load sensor arrangement configured to measure a load carried by the apparatus associated with lifting the belt.

In an aspect, the apparatus includes a cradle adapted to support the conveyor belt, a base arrangement adapted to seat with the supporting structure and a lifting mechanism operatively coupled between the base arrangement and the cradle so that the conveyor belt is elevatable in a supported condition.

In another aspect, the load sensor arrangement is adapted to measure the load between the apparatus and the supporting structure.

In yet another aspect, the load sensor arrangement is adapted to measure a load between the base and the support structure.

In yet another aspect, the base arrangement includes a base and first and second supports arranged between the base and the supporting structure.

In yet another aspect, at least one of the first and second supports includes the load sensor arrangement.

In yet another aspect, only one of the first and second supports includes the load sensor arrangement.

In yet another aspect, at least one of the first and second supports is arranged to allow at least some lateral movement of the base relative to the support structure.

In yet another aspect, both of the first and second supports are arranged to allow at least some lateral movement of the base relative to the support structure.

In yet another aspect, at least one of the first and second supports includes a locating part arrange to locate the respective the first and second supports with the supporting structure.

In yet another aspect, the locating part is adapted to inhibit lateral movement of the respective at least one of the first and second supports.

In yet another aspect, both of first and second supports includes a locating part arrange to inhibit lateral movement of the respective at least one of the first and second supports.

In yet another aspect, the first support includes a body adapted to allow at least some lateral movement of the base and a locating part adapted to inhibit lateral outward movement of the first support, and wherein the load cell arrangement includes a load cell fitted between the locating part and the body.

In yet another aspect, the load sensor is configured to communicate a signal indicative of the load with external device.

In yet another aspect, the lifting mechanism includes one or more jacks.

In yet another aspect, the jack is a screw jack.

In yet another aspect, the base arrangement includes a base and first and second supports, the base having an elongate support member adapted to span spaced apart frame members of a supporting structure, and the first and second supports being located toward opposing ends of the base and locating with the paced apart frame members.

In yet another aspect, the cradle includes two cradle sections pivotally coupled to the lifting mechanism.

In yet another aspect, the load sensor arrangement is adapted to provide an alert if the load is greater than a predetermined load.

In accordance with a second broad aspect there is provided, an apparatus for lifting a conveyor belt relative to a supporting structure, the apparatus including a cradle adapted to support the conveyor belt, a base adapted to seat on the supporting structure and a lifting mechanism operatively coupled between the base and the cradle so that the conveyor belt is elevatable in a supported condition, wherein the apparatus includes a load sensor arrangement arranged to measure a load associated with the belt in the supported condition.

In accordance with a third broad aspect there is provided, a system for lifting a conveyor belt, the system including a lifting apparatus adapted to lift a conveyor belt, a sensor arranged to provide a signal indicative of a load carried by the lifting apparatus and a computer configured to receive the signal and provide an alert if the load exceeds a pre-determined load value.

In accordance with a fourth broad aspect there is provided, a method for lifting a conveyor belt, the method including the steps of: Fitting an apparatus to a supporting structure of the conveyor belt, with a base seated on the supporting structure and a cradle arranged to support the conveyor belt; Elevating the cradle using a lifting mechanism operatively coupled between the base and the cradle so that the conveyor belt is elevated in a supported condition; Monitoring, using a load sensor arrangement fitted between the cradle and the supporting structure, a load value indicative of a load associated with the conveyor belt, and providing an alert if the load value exceeds a pre-determined load value.

In accordance with a fifth broad aspect there is provided, an apparatus adapted to lift a conveyor belt relative to a supporting structure, the apparatus including a load sensor arrangement configured to measure a load carried by the apparatus associated with lifting the belt, and provide an indication if the load is greater than a predetermined value.

Further aspects, features and functions of the apparatus, system and methods are detailed in the description below.

### BRIEF DESCRIPTION OF THE FIGURES

The invention is described, by way of non-limiting example only, by reference to the accompanying figures, in which;

FIG. 1 is a perspective view illustrating an apparatus for lifting a belt;

FIG. 2 is an exploded parts view illustrating the apparatus;

FIG. 3 is an exploded parts view illustrating a lifting mechanism of the apparatus;

FIG. 4 is a further exploded parts view illustrating the lifting mechanism of the apparatus;

FIG. 5 is a top view illustrating the apparatus;

FIG. 6 is an end view illustrating the apparatus;

FIG. 7 is an opposing end view illustrating the apparatus;

FIG. 8 is a side view illustrating the apparatus in a lowered condition;

FIG. 9 is a side view illustrating the apparatus in a raised condition;

FIG. 10 is a part side sectional view illustrating the opposing end view of the apparatus;

FIG. 11 is an end view illustrating a sensor arraignment of the apparatus including a load cell;

FIG. 12 is an exploded parts view illustrating the sensor of the apparatus including the load cell;

FIG. 13 is a perspective side view illustrating the apparatus fitted to a support structure to lift a conveyor belt;

FIG. 14 is another perspective side view illustrating the apparatus fitted to the support structure to lift the conveyor belt; and

FIG. 15 is a block diagram illustrating system for lifting a conveyor belt and providing an alert if a predetermined load is exceeded.

### DETAILED DESCRIPTION

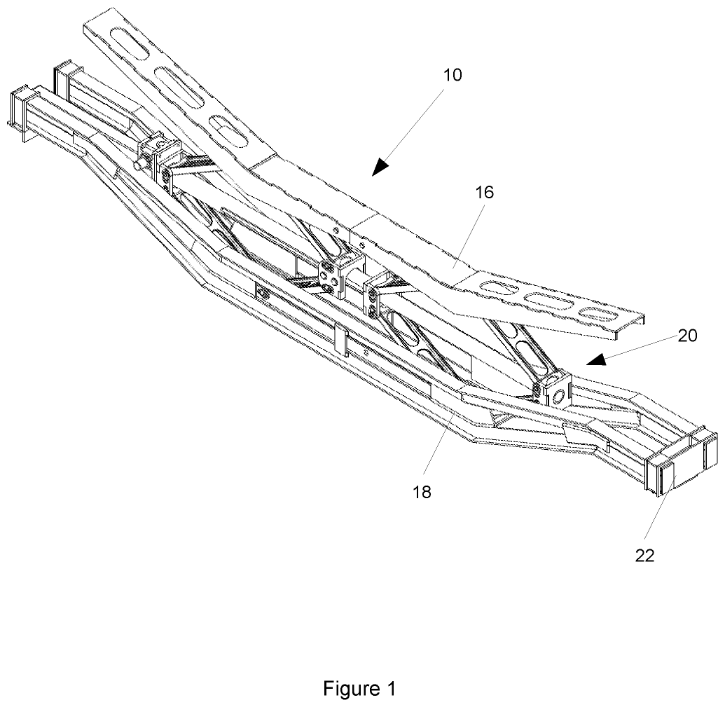

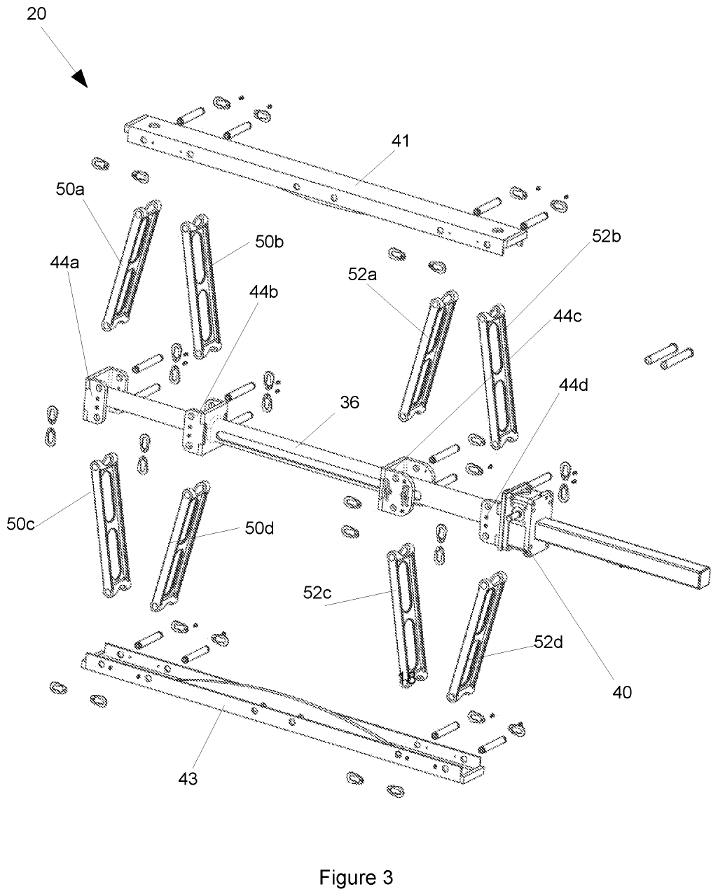

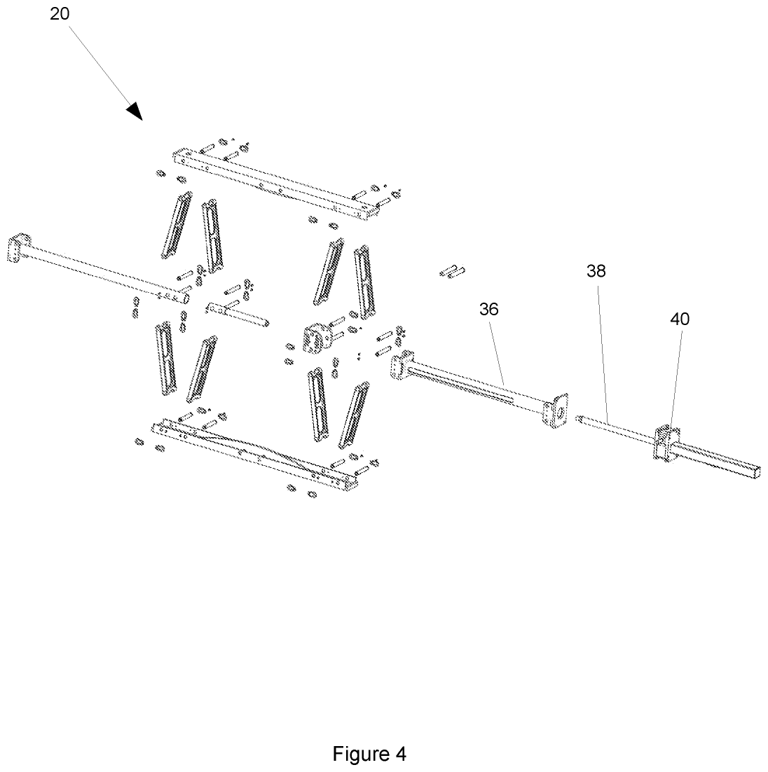

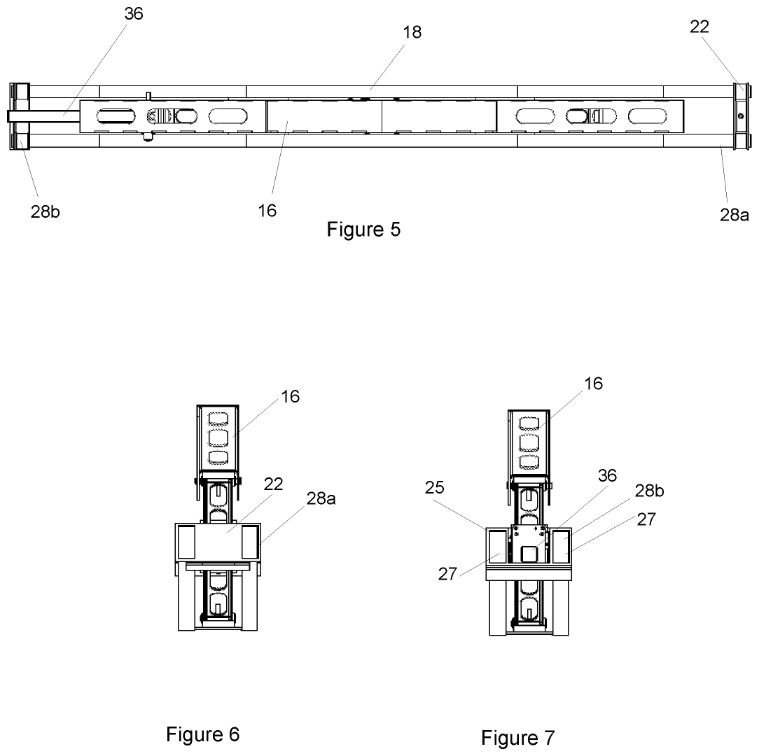

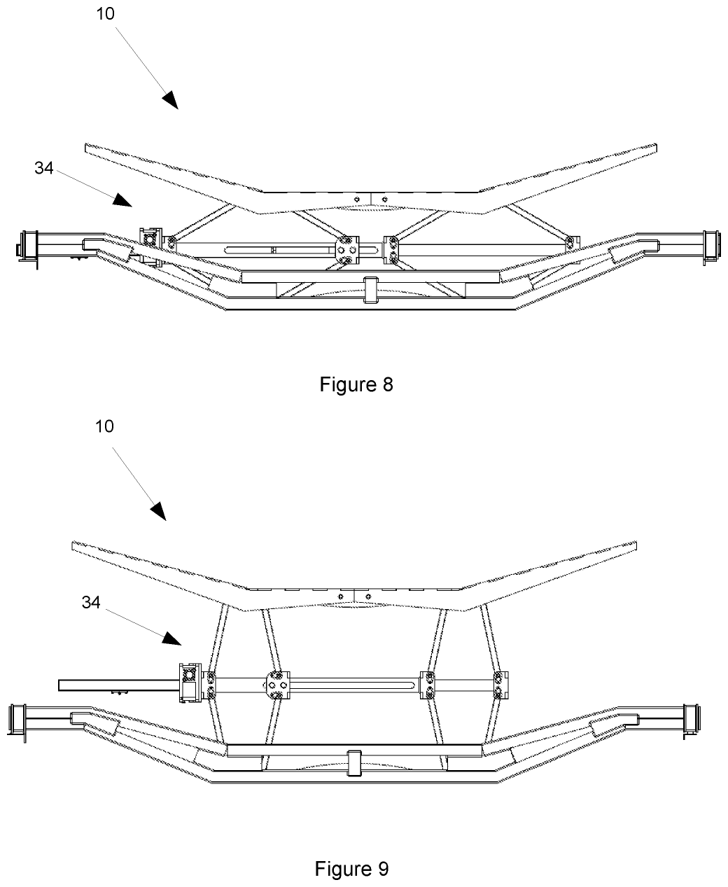

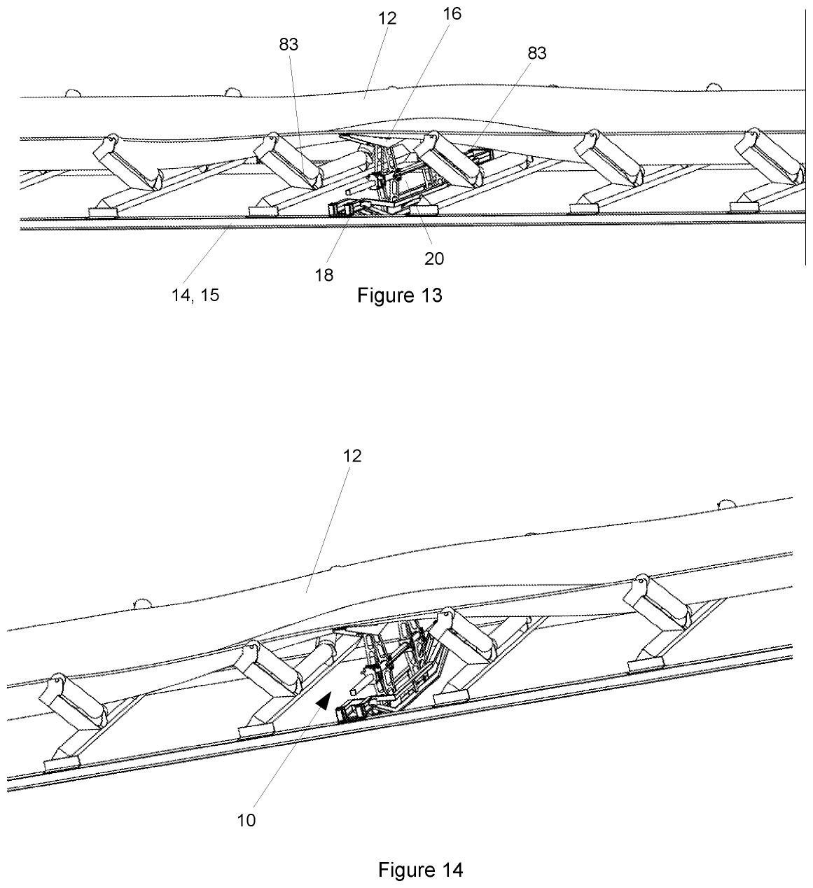

Referring to FIGS. 1 to 12, there is shown an apparatus 10 for lifting a conveyor belt 12 relative to a supporting structure 14 such as a conveyor belt support frame 15. The belt 12, supporting structure 14 and frame being shown in FIGS. 13 and 14. The apparatus 10 includes a cradle 16 adapted to support the conveyor belt 12, a base arrangement 17 to engage with the supporting structure 14 and a lifting means or mechanism 20 operatively coupled between the base 18 and the cradle 16.

The lifting mechanism 20 is arranged to lift the conveyor belt 12 in a supported condition in which the conveyor belt 12 is supported or seated on the cradle 16 and the cradle 16 is elevatable relative to the base 18. The apparatus 10 includes a load sensor arrangement 22 configured to monitor and measure a load associated with the conveyor belt 12 in the supported condition. The base arrangement 17 includes a base 18 and first and second locators or supports 21, 23 to locate the base 18 relative to the supporting structure 14. The load sensor arrangement 22 is provided in this example as part of the first support 23. However, in other example, the load sensor arrangement 22 may be located elsewhere on or within the apparatus 10.

The load may be measurable at any point of elevation such as a lowered condition in which the conveyor belt 12 is not yet elevated and is in or toward its normal lowered position, a lifting condition in which the conveyor belt 12 is being lifted and a lifted condition in which the conveyor belt 12 is at or toward its fully elevated position, such as this shown in FIGS. 13 and 14.

The apparatus 10 may be include multiple parts or may be formed as an integral structure or unit. In some examples, the apparatus 10 may be formed by modification or adaptation of existing belt lifters by adding, for example, the load sensor arrangement 22.

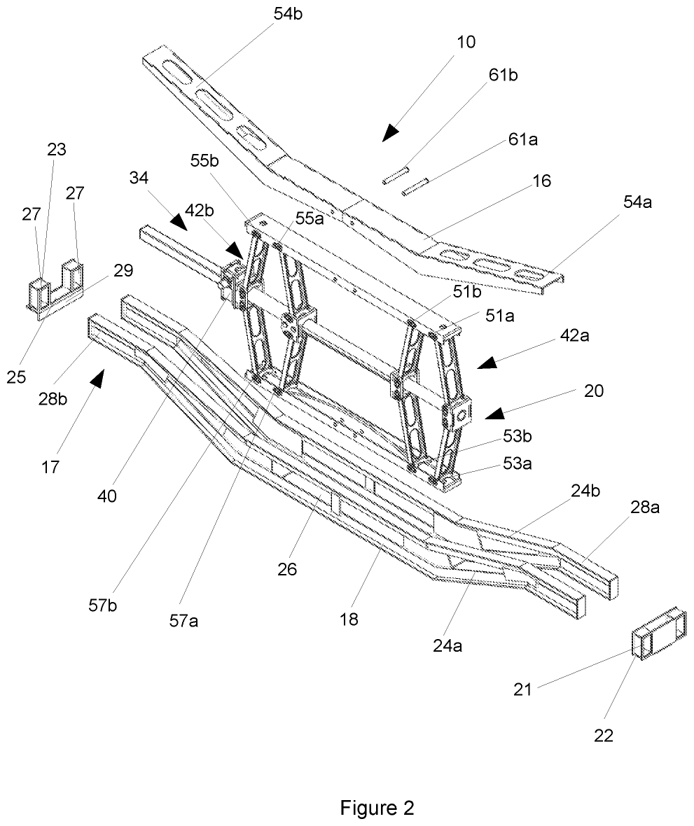

In more detail, turning firstly to the structure of the apparatus 10 and referring more specifically to FIGS. 2 to 10. The base 18 includes two spaced apart members 24a, 24b that are coupled by one or more intermediate transverse members 26 upon which the lifting mechanism 20 is supported. The base 18 includes first and second free end portions 28a, 28b that are dimensioned to seat on or span the supporting structure 14.

In this example, one of the end portions 28a is fitted with the first locator or end support 21 that includes the load sensor arrangement 22 and the other end 28b is fitted with the second locator or end support 23. The supports 21, 23 are adapted to couple the two spaced apart members 24a, 24b for locating with the supporting structure 14. The end support 23 includes a body 25 with apertures 27 to receive the two spaced apart members 24a, 24b and an angled locating section or part 29 to locate with the supporting structure 14.

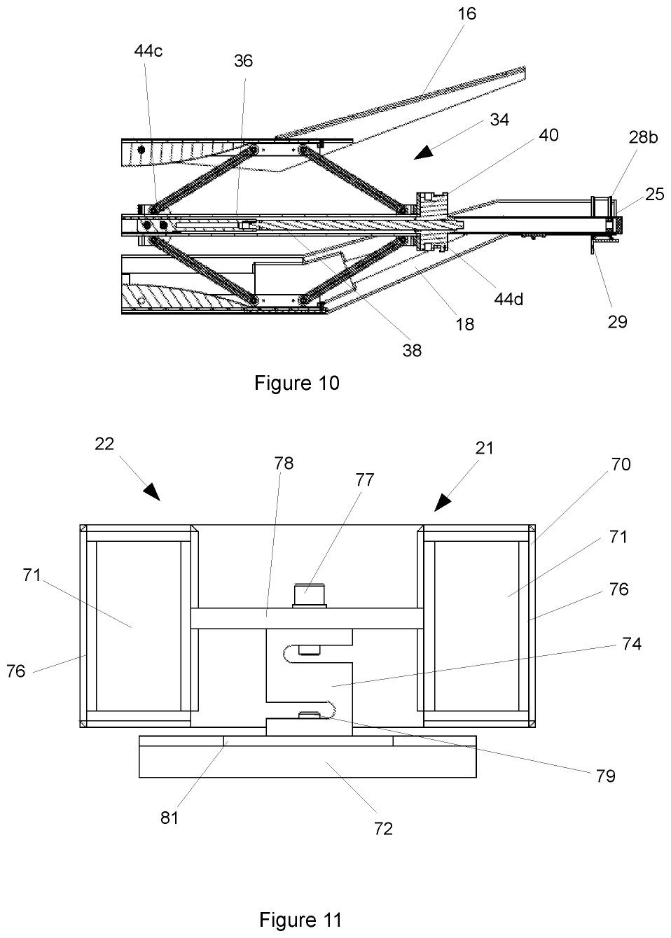

The lifting mechanism 20 is supported by the one or more intermediate transverse members 26 of the base 18 and includes a jack arrangement 34, more specifically a self-locking horizontal screw jack. The jack arrangement 34 includes an elongate transverse member 36 housing a translating screw 38 (shown best in FIG. 10) that is actuated by an actuation mechanism 40, an upper member 41, a lower member 43 and two pairs of jack linkage members 42a, 42b extending between the upper member 41 and lower member 43.

The elongate transverse member 36 carries four intermediate couplings 44a, 44b, 44c and 44d, two for each of the pairs of jack linkage members 42a, 42b. The first of the two pairs of jack linkage members 42a includes four members 50a, 50b, 50c, 50d. Members 50a, 50b are pivotally coupled between couplings 51a, 51b at the top member 41 and intermediate couplings 44c, 44d, and members 50c and 50d are coupled between intermediate couplings 44c, 44d and pivotal couplings 53a, 55b at the bottom member 43.

Similarly, the second of the two pairs of jack linkage members 42b includes four members 52a, 52b, 52c, 52d. Members 52a, 52b are pivotally coupled between couplings 55a, 55b at the top member 41 and intermediate couplings 44a, 44b, and members 50c and 50d are coupled between intermediate pivotable couplings 44a, 44b and pivotal couplings 57a, 57b at the bottom member 43.

Each of the four pivotable couplings 44a, 44b, 44c and 44d carried by the elongate transverse member 36 are arranged to relatively move in a transverse direction with actuation of the screw 38 so as to narrow or splay the two pairs of jack linkage members 42a, 42b to raise and lower the cradle 16 upon actuation of the actuation mechanism 40. In some examples, one the couplings 44a, 44b may be fixed, and one of the couplings 44c and 44d may be fixed. In this example, couplings 44a and 44c are a fixed pair and move together same as couplings 44b and 44d.

The actuation mechanism 40 is located toward one of the end portions 28b so as to be clear of and not directly under the middle of the cradle 16. In this example, the actuation mechanism 40 is adjacent intermediate coupling 44d. The actuation mechanism 40 may be motor or hand operated, and in this example, may include a worm gear box (not shown) such as, but not limited to, having a 28:1 gear ratio adapted to rotate the screw 38 which in turn moves, in this example, intermediate pivotable couplings 44a and 44d and thus may raise and lower the two pairs of jack linkage members 42a, 42b.

The cradle 16 is releasably coupled atop the top member 41 of the lifting mechanism 20 and may be interchanged with alternative sized and shaped cradles, as required. In this example, the cradle 16 includes two halves or cradle sections 54a and 54b that are arranged to be seated and be coupled to the top member 41 by pins 61a and 61b.

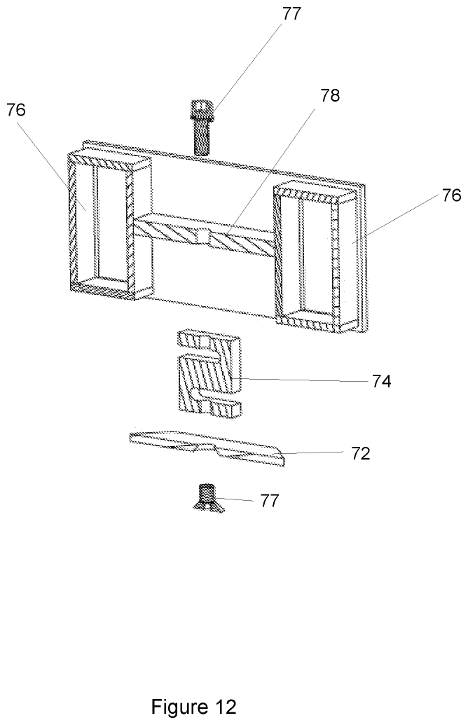

Turning to the load sensor arrangement 22 in more detail, and referring to FIGS. 11 and 12, in this example, the load sensor arrangement 22 is provide as part of the first support 21 and includes a body 70 with spaced apart apertures 71 arranged to locate and support the free end portions 28a of the base 18, a sensor base 72 arranged to located with and to bear on the supporting structure 14, and a load cell 74 arranged between the body 70 and the sensor base 72 to allow measurement of load ultimately between a convenor upon the cradle 16 and the supporting structure 14.

In this example, the body 70 includes two rectangular sections 76, that provide the apertures 71, arranged to fit with the free end portions 28a of the base 18 and a bridge member 78 extending between the two rectangular sections 76. The load cell 74 is then fitted between the bridge member 78 and the sensor base 72 with the body 70 floating on the load cell 74 above the sensor base 72. The load cell 74 may be an S-Type load cell and fasteners 77 and 79 may be used to secure the load cell 74 to the bridge member 78 and the sensor base 72, respectively. However, other types of load cells may be used. The sensor base 72 may include an angled section or locating part 81 for locating with the support structure 14 and inhibiting lateral outward movement of the sensor base 72.

It is noted that the first and second supports 21, 23, more specifically the open ends of the bodies 25 and 70 thereof, that support the opposing ends 28b and 28a, respectively—allow the ends 28b, 28 to move laterally relative thereto so as to minimize shear force placed onto the load cell 74. Thereby allowing the measured load to more accurately reflect the vertical load carried by the apparatus 10 and hence the load associated with the belt 12. In other words, the arrangement services to at least partially isolate out the vertical load.

The overall load may be determined by assuming that the load on each of the end portions 28a, 28b is about the same. It is noted that whilst in this example a single load cell 74 is shown, in other examples, multiple load cells or other forms of load sensor arrangements may be used, such as but not limited to, springs, gauges and hydraulic pressure sensors.

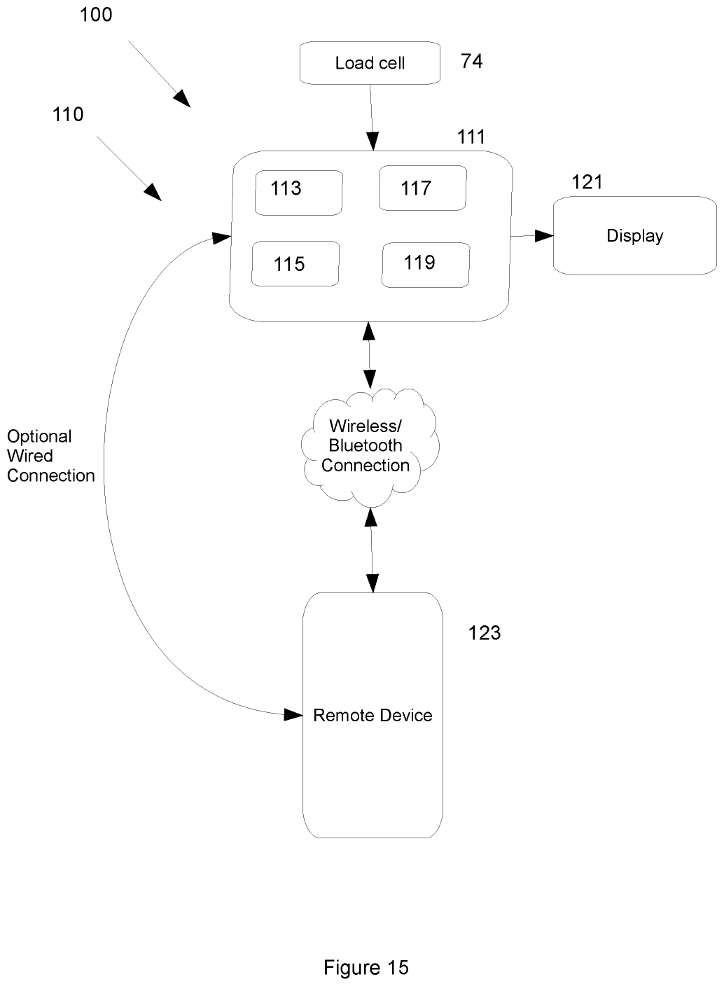

Referring additionally to FIG. 15, the apparatus 10 preferably forms part of a system 100 that includes a computer arrangement 110 arranged to communicate with the load sensor arrangement 22. The computer arrangement 110 being configurable by software to receive and process a signal from the load cell 74 of the load sensor arrangement 22 to provide data, such as values, representative of the load.

The computer arrangement 110 includes one or more computers 111 that in this example may be a micro-controller 113 having a processor 115, memory 117 and a communication module 119 such as a blue tooth communication module. The computer arrangement 110 may also include a remote computing device 123. The communication device 119 may be adapted to communicate the load signal with the remote computer device 123 such as a smart phone or table.

The computer arrangement 110 may be located locally at or on the apparatus 10 or may be partly or fully remote to apparatus 10. The computer arrangement 110 may be or interface with an external control system, such as a main plant control system.

In some examples, the computer arrangement 110 may be configured to store in memory 117 pre-determined values such as maximum load values. The computer arrangement 110 may then be configured to receive the signal from the load cell 74 in real-time, and in real-time, compare at processor 115, the measured load values to the pre-determined values.

If, for example, the measured load values exceed the relevant pre-determined value, then the computer arrangement 110 may be configured to provide an alert. The alert could be in any suitable form such as a message, sound, light or the like. In this example, a display 121 may be provided at or associated with the apparatus 10 that may include lights such as LED lights to provide in indication of load. For example, a RED LED light may be illuminated to indicate an overload condition. The load status such as under load, working load or overload may also be communicated to and be displayable via the remote computing device 123 or aforementioned plant control system.

Accordingly, the system 110 is able to detect an overload condition or other load condition in real-time, and provide an alert in real-time to an operator or to a motor (not shown) thereby assisting to reduce or eliminate overloading. The apparatus 10 may, for example, be designed to lift between, but not limited to, 1000 kg to 5000 kg, preferably around 2,500-3000 kg. If for example, the design limit was 3000 kg then an initial warning alert could be generated at 2500 kg and an overload alert at 3000 kg.

In use, the apparatus 10 may be fitted to the support structure 14 between conveyor rollers 83 as best shown in FIGS. 13 and 14. The apparatus 10 may be provided in different sizes and depending on the size may be fitted into place by hand or require a lift such as by a crane. The apparatus 10 may then be operated by the actuation mechanism 40 to move the jack arrangement 34 which elevates the cradle 16 to engage with and lift the belt 12.

The system 110 is configured to monitor the load at the load cell 74 during the lifting and provide an alert in real-time to an operator or to a motor (not shown) thereby assisting to reduce or eliminate overloading. In an overloaded condition, work may be stopped, load may be removed from the belt 12 and/or the apparatus 10 may be lowered.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

1-23. (canceled)

24. An apparatus adapted to lift a conveyor belt relative to a conveyor frame and measure a load associated with lifting the conveyor belt, the apparatus including:
a cradle adapted to support the conveyor belt;
a base arrangement adapted to seat with and span spaced apart members of the conveyor frame;
a lifting mechanism operatively coupled between the base arrangement and the cradle so that the conveyor belt is elevatable in a supported condition; and
a load sensor arrangement configured to measure a load between the base arrangement and the conveyor frame associated with lifting the conveyor belt.

25. The apparatus according to claim 24, wherein the base arrangement includes a base with an elongate support member adapted to span the spaced apart frame members, and a first support and a second support arranged toward opposing ends of the elongate support member between the base and the spaced apart frame members,
wherein at least one of the first support and the second support includes the load sensor arrangement.

26. The apparatus according to claim 25, wherein only one of the first support and second supports includes the load sensor arrangement.

27. The apparatus according to claim 25, wherein at least one of the first support and the second support is arranged to allow at least some lateral movement of the base relative to the conveyor frame.

28. The apparatus according to claim 27, wherein both of the first support and second support are arranged to allow at least some lateral movement of the base relative to the conveyor frame.

29. The apparatus according to claim 25, wherein at least one of the first support and the second support includes a locating part arranged to locate the respective at least one of the first support and the second support with the conveyor frame.

30. The apparatus according to claim 29, wherein the locating part is adapted to inhibit lateral movement of the respective at least one of the first support and second support relative to the conveyor frame.

31. The apparatus according to claim 25, wherein both of the first support and second support include a locating part arranged to inhibit lateral movement of the respective at least one of the first support and the second support relative to the conveyor frame.

32. The apparatus according to claim 25, wherein the first support includes a body adapted to allow at least some lateral movement of the base and a locating part adapted to inhibit lateral outward movement of the first support, and wherein the load sensor arrangement includes a load cell fitted between the locating part and the body.

33. The apparatus according to claim 25, wherein the load sensor arrangement is configured to communicate a signal indicative of the load with an external device.

34. The apparatus according to claim 24, wherein the lifting mechanism includes one or more jacks.

35. The apparatus according to claim 34, wherein the one or more jacks include a screw jack.

36. The apparatus according to claim 35, wherein the screw jack includes two pairs of jack linkage members adapted to be actuated by a translating screw housed by an elongate transverse member.

37. The apparatus according to claim 24, wherein the base arrangement includes a base and a first support and a second support, the base having an elongate support member adapted to span the spaced apart frame members of the conveyor frame, and the first support and the second support being located toward opposing ends of the base and adapted to locate with the spaced apart frame members.

38. The apparatus according to claim 24, wherein the cradle includes two cradle sections pivotally coupled to the lifting mechanism.

39. The apparatus according to claim 25, wherein the load sensor arrangement includes a load cell fitted to at least one of the first and second supports.

40. The apparatus according to claim 24, wherein the load sensor arrangement is adapted to provide an alert if the load is greater than a predetermined load.

41. The apparatus according to claim 25, wherein at least one of the first support and the second support include body with a through aperture adapted to receive and allow lateral movement therethrough of the elongate support member.

42. An apparatus to lift a conveyor belt relative to a conveyor frame and measure a load associated with lifting the conveyor belt, the apparatus including:
a cradle adapted to support the conveyor belt;
a base adapted to span between and seat on spaced members of the conveyor frame; and
a lifting mechanism operatively coupled between the base and the cradle so that the conveyor belt is elevatable in a supported condition,
wherein the base includes an elongate support member adapted to span the spaced apart frame members, and a first support and a second support arranged between the elongate support member and the conveyor frame,
wherein at least one of the first support and the second support includes a load cell arranged to provide a signal indicative of a load between the base and the conveyor frame associated with lifting the belt in the supported condition.

43. A system for lifting a conveyor belt, the system including an apparatus for lifting a conveyor belt as defined in claim 42 and a computer configured to receive the signal and provide an alert if the load exceeds a pre-determined load value.
